(19) United States
(12) Patent Application Publication
(10) Pub. No.: US 2012/0320291 A1
(43) Pub. Date: Dec. 20, 2012

(54) TRANSPARENT 3D DISPLAY SYSTEM

(75) Inventors: Sam Yang, Shanghai (CN); Peter G. Diehl, Frankfurt am Main (DE)

(73) Assignee: GM GLOBAL TECHNOLOGY OPERATIONS LLC, Detroit, MI (US)

(21) Appl. No.: 13/160,081

(22) Filed: Jun. 14, 2011

(51) Int. Cl. G02F 1/1335; G02B 27/22

(52) U.S. Cl. 349/15; 359/463

(57) ABSTRACT

A transparent 3D display system comprises a display sheet and a barrier mask, the barrier mask being separated from the display sheet by an optical thickness. The barrier mask is separated from a viewer having a right eye and a left eye. The display sheet is configured to display an image comprising first and second sets of image strips, and the barrier mask is configured to produce a plurality of alternating viewing strips and blocking strips. The viewing strips are positioned, oriented, and configured so as to allow the right eye to view the first set of image strips and the left eye to view the second set of image strips, and the blocking strips are positioned, oriented, and configured to prevent the right eye from viewing the second set of image strips and the left eye from viewing the first set of image strips.

### FIELD OF THE INVENTION

The subject invention relates generally to vehicle display systems and more specifically to a transparent 3D display system enabling a viewer's perception of image depth without use of specialized 3D glasses.

### BACKGROUND

In today's world, automobiles are becoming increasingly complex, providing an ever-increasing array of features and capabilities. Often, these features are made more useful or effective by providing information to vehicle operators and other occupants. As a result, automobile manufacturers and others are continually seeking new systems and methods for presenting information to vehicle occupants.

In most automobiles, a large amount of window area exists at the level of the viewer's eyes, usually including a windshield and typically also including windows on the sides and rear of the vehicle. Other viewing surfaces, such as video screens and other displays, may be present in the vehicle's dashboard instrument panels, infotainment systems, and console. Yet, use of these surfaces for presentation of additional information (e.g., heads-up displays) remains relatively uncommon. One apparent reason for this underutilization of window space is that conventional display technology tends to obscure the view through the window or other display screen. Another perceived drawback is the lack of perceptible depth in images presented in conventional heads-up displays.

Accordingly, it is desirable to provide a system and method to enable visual presentation of information on a vehicle's windows and other display screens without unreasonably interfering with the occupants' view through the windows or the occupants' perception of images displayed on another underlying viewing screen. It would also be desirable to have a system that could present information to a vehicle occupant upon a window or display screen without blocking or obscuring the occupant's view through the window or of the display. It would also be advantageous to have a transparent displaying system that could be integrated with a vehicle window or other display screen and that could facilitate a viewer's perception of depth in the image (i.e., presenting information in the form of a 3-dimensional image) without requiring the viewer to wear special glasses.

### SUMMARY OF THE INVENTION

In a first aspect of the invention, a transparent 3D display system comprises a display sheet and a barrier mask, wherein the barrier mask is separated from the display sheet by an optical thickness, and the barrier mask is separated from a viewer by a viewing distance. The display sheet is configured to display an image comprising first and second sets of image strips, and the barrier mask is configured to produce a plurality of alternating viewing strips and blocking strips. The viewing strips are positioned, oriented, and configured so as to allow the right eye to view the first set of image strips and the left eye to view the second set of image strips, and the blocking strips are positioned, oriented, and configured to prevent the right eye from viewing the second set of image strips and the left eye from viewing the fist set of image strips.

In another aspect of the invention, a method for displaying a 3D image comprises segmenting an image into at least two sets of image strips, and deflecting each of the sets of image strips so as to position, orient, and configure each of the sets of image strips in a manner that substantially allows a right eye of a viewer to view the first set of image strips and a left eye of the viewer to view the second set of image strips.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a simplified schematic top view of an exemplary overlain display system;

FIG. 2 is a schematic drawing of an exemplary overlain display system with a barrier mask in a transparent state;

FIG. 3 is a schematic drawing of an exemplary overlain display system with a barrier mask in a non-transparent state;

FIG. 4 is a schematic drawing of an exemplary display system with a barrier mask comprising a lenticular sheet; and

FIG. 5 is a flow chart showing an exemplary method for displaying an image.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

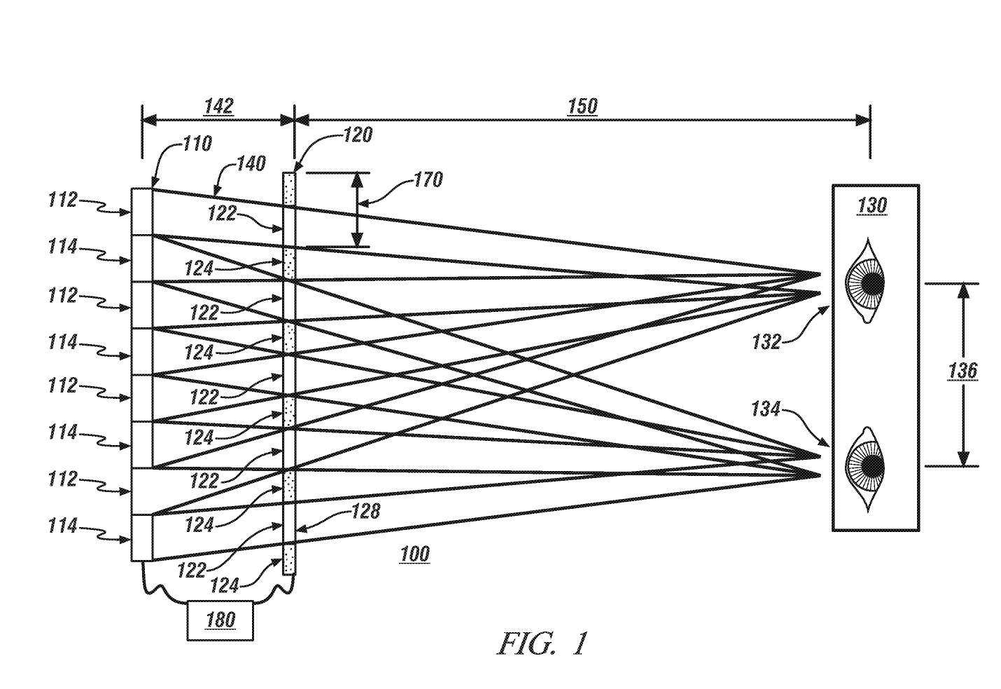

In accordance with an exemplary embodiment of the invention, as shown in FIG. 1, an exemplary overlain display system 100 includes a display sheet 110 and a barrier mask 120 that is positioned between display sheet 110 and a viewer 130. Display sheet 110 and barrier mask 120 are separated by a sheet 140 of transparent material, such as glass, having an optical thickness 142. Viewer 130 comprises a right eye 132 and a left eye 134 that are separated by an inter-ocular distance 136. Barrier mask 120 and viewer 130 are separated by a viewing distance 150. Overlain display system 100 may be applied to a viewing surface in a vehicle such as a windshield, a window, a rear-view mirror, a vanity mirror, an infotainment display screen, a dashboard display, or another similar viewing surface.

In operation, display sheet 110 presents images comprising image strips 112, which are intended for viewing by right eye 132. Images presented by display sheet 110 also comprise image strips 114, which are intended for viewing by left eye 134. To facilitate viewing of image strips 112 by only right eye 132 and viewing of image strips 114 by only left eye 134, barrier mask 120 comprises viewing strips 122 and blocking strips 124, which are all oriented substantially parallel to image strips 112 and 114. To facilitate a viewer's perception of depth, image strips 112, 114, viewing strips 122, and blocking strips 124 are all oriented substantially perpendicular to a line passing through both right eye 132 and left eye 134. For example, when right eye 132 and left eye 134 are oriented on a horizontal line, image strips 112, 114, and viewing strips 122, and blocking strips 124 are all oriented substantially vertically.

To accomplish this, video processing unit 180 controls the presentation (i.e., the composition, orientation, and width) of image strips 112 and 114 and of viewing strips 122 and blocking strips 124 so as to create a transparent displaying system which can present images providing viewer 130 with a perceived effect, such as depth, thereby producing a 3-dimensional viewing experience without requiring special glasses. Thus, the system provides a transparent displaying system that is able to show videos and signals as glasses-free true 3D images to users. This system may be combined with front windshield, side windows and other infotainment components to present information to vehicle occupants such as videos, warning signals, navigation information, rear parking assistant vision and the like.

In essence, strips of pixels are displayed on a first surface while a selective visual barrier is created on a second surface positioned between the first surface and a viewer. By controlling the distance of the visual barrier from the first surface, a right eye of the viewer can be permitted to see only a first set of pixel strips while a left eye of the viewer is permitted to see only a second set of pixel strips that differs from the first set in a way that causes the viewer to perceive a combined image having depth.

In an exemplary embodiment, display sheet 110 is a transparent display comprising an electro-luminescent material. For example, display sheet 110 may comprise a phosphorescent material such that, when image forming electrodes 105 of display sheet 110 are not activated (i.e., inactive), a corresponding area of display sheet 110 remains transparent. When the electrodes 105 are activated (i.e., active), however, an area corresponding to the activated electrodes emits luminescence. Accordingly, the display sheet may be caused to exhibit an image or to transmit or reflect or emit light as may be desired or commanded by the system. Light filters can be used over display sheet to produce various colors. The richness of contents is based on the size of electrodes. The resolution can be the same as typical liquid crystal displays.

Barrier mask 120 comprises a liquid crystal panel and a set of transparent electrodes configured to produce a series of alternating viewing strips 122 and blocking strips 124. Viewing strips 122 are configured to allow light to pass, thereby enabling viewer 130 to perceive an image presented by display sheet 110. Viewing strips 122 accomplish this function by exhibiting a transparent or light-transmitting quality. Blocking strips 124 are configured to obscure viewing of a light image, such as by exhibiting an opaque or light-absorbing or light reflecting quality. Viewing strips 122 are positioned, oriented, and configured so as to substantially allow a right eye 132 of the viewer 130 to view image strips (i.e., interlaces) 112 and a left eye 134 of viewer 130 to view image strips (i.e., interlaces) 114. Transparent electrodes are energized so as to position, orient, and configure blocking strips 124 so that they substantially prevent a right eye 132 of viewer 130 from viewing image strips 114 and a left eye 134 of viewer 130 from viewing image strips 112.

As one skilled in the art will appreciate, a quantity of “n” viewing strips 122 are necessary to enable a right eye 132 of viewer 130 to view a quantity of “n−1” image strips 112 while a left eye 134 of viewer 130 views a quantity of “n−1” image strips 114. Similarly, a quantity of “n” of blocking strips 124 are necessary to prevent a right eye 132 of viewer 130 from viewing a quantity of “n−1” image strips 114 while also preventing a left eye 134 of viewer 130 from viewing a quantity of “n−1” image strips 112.

It should also be appreciated that, in order to provide for alignment of image strips 112, 114, viewing strips 122, and blocking strips 124, a barrier periodic distance 170 (i.e., a distance between adjacent viewing strips 122 or between adjacent blocking strips 124) is set so as to be approximately equal to two times inter-ocular distance 136 divided by the viewing distance 150 plus twice optical thickness 142. Put another way, barrier periodic distance 170 is set according to the following relationship: P=2et/(d+2t), where P is barrier periodic distance 170; e represents the inter-ocular distance 136; t represents the optical thickness 142; and d represents the viewing distance 150. In an alternative embodiment, optical thickness 142 is set to be equal to viewing distance 150×barrier periodic distance 170 divided by the quantity 2 times the inter-ocular distance 136 minus the barrier periodic distance 170. Put another way, the optical thickness 142 is set according to the following relationship: T=pd/2(e−p). More generally, p and/or t are set so that p/t=(2e−p)/(d+t).

In operation, when it is desired to present information via overlain display system 100, a video processing unit 180 causes display sheet 110 to display an image comprising a matrix of pixels arranged in alternating image strips 112, 114. In an exemplary embodiment, video processing unit 180 facilitates display of a 3-dimensional image such that the image comprises both a first set of pixilated image information intended for perception by a right eye 132 of viewer 130 and a second set of pixilated image information that is intended for perception by a left eye 134 of a viewer 130. To facilitate perception of the first set of information by only the right eye 132, video processing unit 180 positions the presentation of the first set of pixilated image information so that it is viewable by right eye 132 but not by left eye 134. To facilitate perception of the second set of information by left eye 134 but not by right eye 132, video processing unit 180 positions the presentation of the second set of pixilated image information so that it is viewable by only left eye 134.

In an exemplary embodiment, video processing unit 180 receives information representing relevant parameters for controlling the presentation. These relevant parameters may include position and orientation information of right eye 132 and left eye 134 of viewer 130, which may be an operator of the vehicle or another vehicle occupant depending upon the desires of the system user. In an exemplary embodiment, the system may also provide information to a second viewer to enable the second viewer to re-position his or her eyes so as to share the perceived experience of the first viewer.

Accordingly, the display system 100 provides a car window mounted display that is not only selectively transparent but also capable of providing a 3-dimensional viewing experience for occupants of the vehicle. The system can thereby provide a rich and instantaneous information experience to a vehicle operator in the operator's direct field of view, without requiring redirection of the operator's eyes.

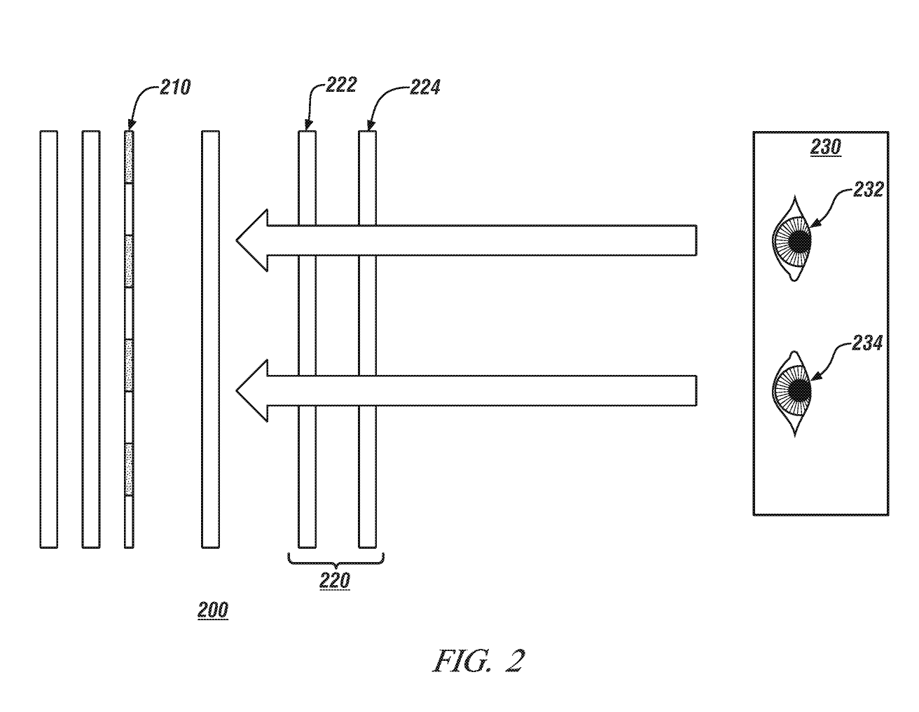

As shown in FIG. 2, an exemplary overlain display system 200 includes a barrier mask 220 in a transparent state. Barrier mask 220 comprises transparent mask electrode 222 and transparent liquid crystal sheet 224. Transparent mask electrode 222 is in a non-energized state enabling liquid crystal sheet 224 to remain in an ordered (i.e., transparent) state, thereby permitting right eye 232 and left eye 234 of viewer 230 to both observe an image displayed on transparent display sheet 210 in its entirety, without obstruction.

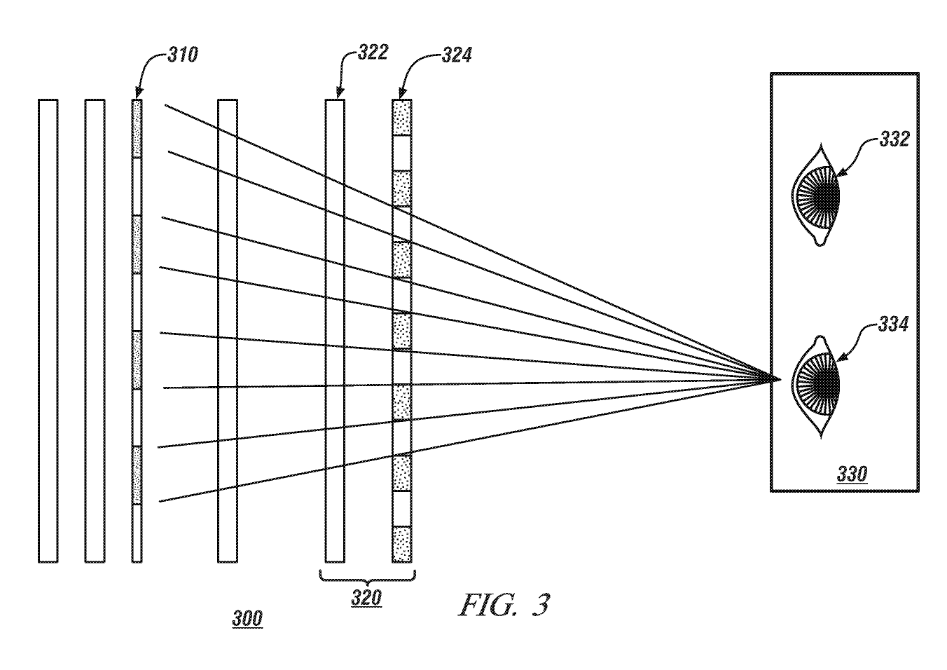

As shown in FIG. 3, an exemplary overlain display system 300 includes a barrier mask 320 in a non-transparent state. Barrier mask 320 comprises transparent mask electrode 322 and transparent liquid crystal sheet 324. Transparent mask electrode 322 is in an energized state so that liquid crystal sheet 324 is in disordered (i.e., non-transparent), selectively enabling right eye 332 to observe only certain strips of an image displayed on transparent display sheet 310 and selectively enabling left eye 334 to observe only certain other strips of the image displayed on transparent display sheet 310.

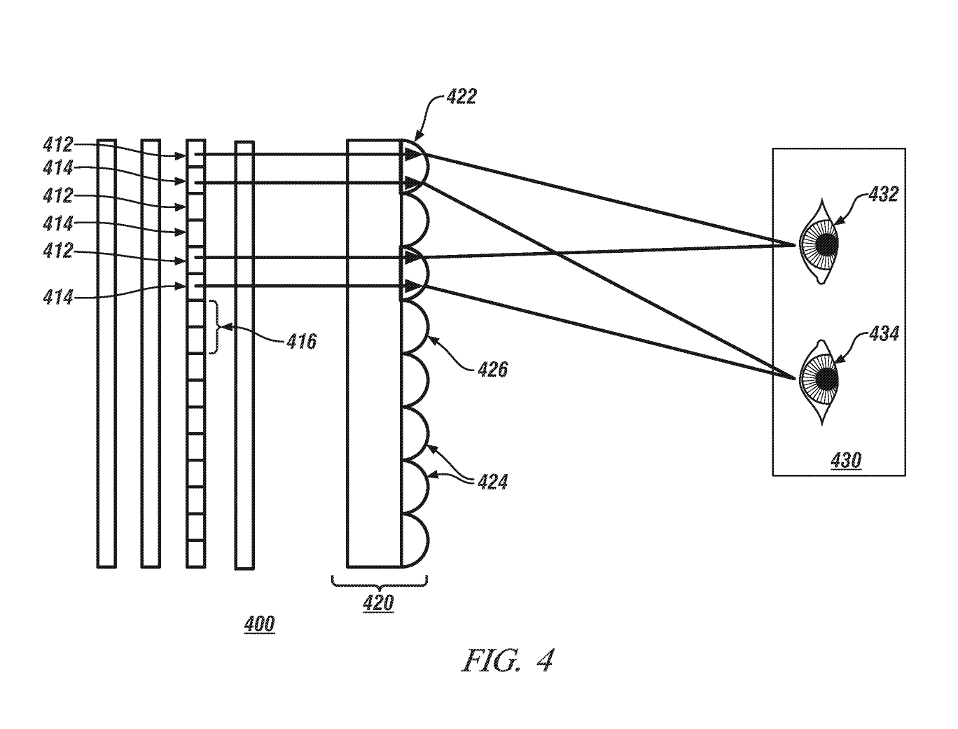

As shown in FIG. 4, an exemplary display system includes a barrier mask 420 comprising a lenticular sheet 422. In accordance with this embodiment, the stripar lenses 424 of lenticular sheet 422 are aligned with image strips 412, 414 of an image, so as to refract light from image strips 412 toward a right eye 432 of viewer 430, and to refract light reflected from image strips 414 toward a left eye 434 of viewer 430. Thus, by matching the lenticular pitch 426 and pixel pitch 416, the system can cause right eye 432 to receive images that differ from images received by left eye 434, thereby enabling, among other things, production of a perception in viewer 430 of depth in the image (i.e., stereoscopic 3D perception).

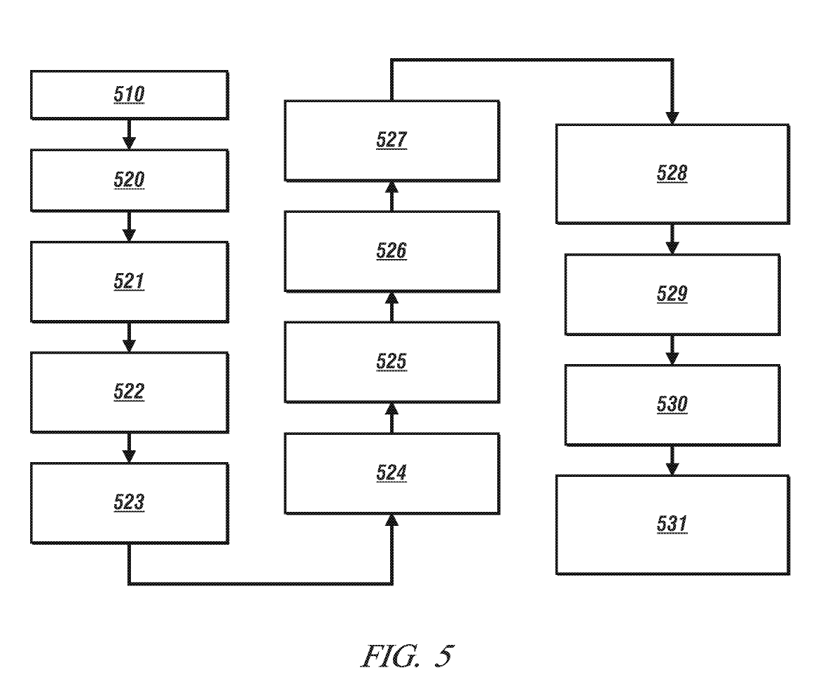

As shown in FIG. 5, a flow chart, showing an exemplary method for displaying an image, is illustrated. In an exemplary embodiment, an image is segmented (step 510) into two sets of image strips (interlaces). Each of the sets of image strips can then be deflected (step 520) so as to be positioned, oriented, and configured so as to substantially allow a right eye of a viewer to view the first set of image strips and a left eye of the viewer to view the second set of image strips. In an exemplary embodiment, the inter-ocular distance between the viewer's eyes is detected (step 521) so that precise adjustments may be made to the arrangement, etc., of the sets of image strips. In an exemplary embodiment, the orientation of viewer's eyes is detected (step 522) so that precise adjustments may be made to the arrangement, etc., of the sets of image strips. The viewing distance is also detected (step 523) so that precise adjustments may be made to the arrangement, etc., of the sets of image strips. The optical thickness may also be detected (step 524) so that precise adjustments may be made to the arrangement, etc., of the sets of image strips. In one embodiment, the optical thickness is adjusted (step 525).

To facilitate viewing of a first set of image strips by only a viewer's right eye and viewing of a second set of image strips by only left eye, a barrier periodic distance is calculated (step 526) and adjusted (step 527). Alternatively, the ratio of the barrier periodic distance to the optical thickness may be calculated (step 528) and either the barrier periodic distance adjusted (step 529) or the optical thickness adjusted (step 530) or both the barrier periodic distance and the optical thickness adjusted (step 531).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A transparent 3D display system comprising a display sheet and a barrier mask;
the barrier mask being positioned between the display sheet and a viewer, the barrier mask being separated from the display sheet by a transparent material having an optical thickness, the barrier mask being separated from the viewer by a viewing distance, and the viewer having a right eye and a left eye separated by an inter-ocular distance;
wherein the display sheet is configured to display an image comprising a first set of image strips and a second set of image strips;
wherein the barrier mask is configured to produce a plurality of alternating viewing strips and blocking strips;
wherein the viewing strips being positioned, oriented, and configured so as to allow the right eye to view the first set of image strips and the left eye to view the second set of image strips; and
wherein the blocking strips are positioned, oriented, and configured to prevent the right eye from viewing the second set of image strips and the left eye from viewing the first set of image strips.

2. The transparent 3D display system of claim 1, wherein the display sheet is a transparent display comprising an electro-luminescent material and a plurality of transparent display electrodes configured to excite the electro-luminescent material to produce the image in the display sheet.

3. The transparent 3D display system of claim 1, wherein the viewing strips are configured to allow light to pass, thereby enabling the viewer to perceive an image presented by the display sheet.

4. The transparent 3D display system of claim 1, wherein the barrier mask comprises a liquid crystal sheet and a set of transparent mask electrodes configured to produce the plurality of alternating viewing strips and blocking strips.

5. The transparent 3D display system of claim 1, wherein the blocking strips are configured to obscure viewing of a light image.

6. The transparent 3D display system of claim 1, wherein the display system is applied to a viewing surface in a vehicle.

7. The transparent 3D display system of claim 2, wherein the display sheet comprises a phosphorescent material such that, when the electrodes are inactive, a corresponding area of the display sheet is transparent, and when electrodes are active, a corresponding area of the display sheet exhibits an image.

8. The transparent 3D display system of claim 1, further comprising one or more light filters disposed between the viewer and the display sheet.

9. The transparent 3D display system of claim 1, wherein a quantity of the viewing strips exceeds by at least one a quantity of image strips in the first set of image strips.

10. The transparent 3D display system of claim 1, wherein a quantity of the viewing strips exceeds by at least one a quantity of image strips in the second set of image strips.

11. The transparent 3D display system of claim 1, wherein the barrier periodic distance is approximately equal to two times the inter-ocular distance divided by a quantity that is equal to the viewing distance plus two times the optical thickness.

12. The transparent 3D display system of claim 1, wherein the optical thickness is approximately equal to the viewing distance multiplied by the barrier periodic distance divided by two times the difference between the inter-ocular distance and the barrier periodic distance.

13. The transparent 3D display system of claim 4, wherein the liquid crystal sheet is configured to be in an ordered state when the mask electrodes are not energized, thereby permitting both the right eye and the left eye of the viewer to both observe an image displayed on the transparent display sheet without obstruction.

14. The transparent 3D display system of claim 4, wherein liquid crystal sheet is configured to be in a disordered state when the mask electrodes are energized, thereby selectively enabling the right eye to observe only certain strips of an image displayed on the display sheet and selectively enabling the left eye to observe only certain other strips of the image displayed on the display sheet.

15. The transparent 3D display system of claim 1, wherein the barrier mask comprises a lenticular sheet having a plurality of lense strips aligned with the image strips so as to refract light from a first set of image strips toward a right eye of the viewer and to refract light reflected from a second set of image strips toward a left eye of the viewer.

16. The transparent 3D display system of claim 1, wherein a pitch of the lense strips of the lenticular sheet is matched to a pitch of the image pixels so as to cause right eye to receive images that differ from images received by left eye.

17. A method for displaying a 3D image comprising:
segmenting an image into at least two sets of image strips; and
deflecting each of the sets of image strips so as to position, orient, and configure each of the sets of image strips in a manner that substantially allows a right eye of a viewer to view the first set of image strips and a left eye of the viewer to view the second set of image strips.

18. The method of claim 17, further comprising detecting an inter-ocular distance between the left eye and the right eye, a viewing distance between a barrier mask and the viewer, and an optical thickness between a display sheet and the barrier mask, and adjusting the position and configuration of blocking strips in a manner that allows a right eye of a viewer to view only the first set of image strips and a left eye of the viewer to view only the second set of image strips.

19. The method of claim 17, further comprising detecting an orientation of the right eye and the left eye and adjusting the orientation of the sets of image strips so as to be substantially perpendicular to a line passing through the right eye and the left eye.

20. The method of claim 17, further comprising determining a desired barrier periodic distance and adjusting the barrier periodic distance to facilitate viewing of a first set of image strips by only a viewer's right eye and viewing of a second set of image strips by only left eye.
